(19) United States
(12) Patent Application Publication
(10) Pub. No.: US 2019/0389039 A1
(43) Pub. Date: Dec. 26, 2019

(54) SCREW FEEDING APPARATUS OF SCREW GUN

(71) Applicants: YOW TAY COLLATED SCREW INDUSTRIAL CO., LTD., TAINAN CITY (TW); ZHONGSHAN JIAZHAN ELECTRIC CO., LTD., ZHONGSHAN CITY (CN)

(72) Inventor: FU-CHUAN TU, TAINAN CITY (TW)

(21) Appl. No.: 16/154,942

(22) Filed: Oct. 9, 2018

(30) Foreign Application Priority Data
Jun. 22, 2018 (TW) 107121567

(51) Int. Cl. B25B 23/04; B25B 21/00

(52) U.S. Cl. CPC B25B 23/04; B25B 21/00

(57) ABSTRACT

A screw feeding apparatus of a screw gun is disclosed. It comprises a screw gun having a main body and a cartridge holder slidably disposed on the main body, a screw cartridge disposed on the cartridge holder, a screw die head disposed at a front end of the screw cartridge, and a feeding assembly disposed at a rear end of the screw cartridge.

### BACKGROUND OF THE INVENTION

### 1. Field of the Invention

The present invention relates to a screw feeding apparatus of a screw gun which saves time and cost and prevents generation of wastes such as a main part of a screw belt due to no need for using a screw belt and inserting plural screws into the screw belt.

### 2. Description of Related Art

Generally, screw guns are used with screw belts. For instance, an automatic screw gun structure of the Taiwan Pat. No. M459968(U) issued on 21 Aug. 2013, a screw gun having an improved transmission structure of the Taiwan Pat. No. M501919(U) issued on 1 Jun. 2015, and a screw gun having reversing prevention effect of the Taiwan Pat. No. M506685(U) issued on 11 Aug. 2015, are the screw guns used with screw belts. The screw belt has a main part and plural screws inserted into the main part and spaced apart from each other. After the plural screws are pushed out of the main part by the screw gun, the main part is discarded as trash and leading to resource waste. The main part made of plastic will not decompose or decay after being buried and produces toxic gas after incineration that leads to environmental pollution. In addition, in manufacturing a screw belt, plural screws are inserted into each of plural apertures of the main part one by one that is time consuming and costs high. Furthermore, it may cause inconvenience in the subsequent screwing operation of the screw gun if the screws are not inserted properly due to missing few screws or tilting insertion.

### SUMMARY OF THE INVENTION

The present invention relates to a screw feeding apparatus of a screw gun which saves time and cost and prevents generation of wastes such as a main part of a screw belt due to no need for using a screw belt and inserting plural screws into the screw belt.

The main purpose and effects of the screw feeding apparatus of a screw gun of the present invention are disclosed by the following features.

The screw feeding apparatus of a screw gun of the present invention comprises a screw gun, a screw cartridge, a screw die head and a feeding assembly. The screw gun has a main body and a cartridge holder slidably disposed on the main body. The screw cartridge is disposed in the cartridge holder and having a groove. The screw die head is disposed at a front end of the screw cartridge, and the feeding assembly is disposed at a rear end of the screw cartridge. Plural screws are filled into the groove of the screw cartridge directly, and the first screw is clamped and positioned by the screw die head at the front end of the screw cartridge. The last screw at the rear end of the screw cartridge is pushed by the feeding assembly to drive the screws filled in the groove to move forward. Accordingly, the screw gun having the screw feeding apparatus of the present invention dose not require the insertion of screws into a screw belt which can save cost and time and prevent generating wastes such as a main part of a screw belt so as to achieve an environmental protection benefit.

### BRIEF DESCRIPTION OF THE DRAWINGS

FIG. 1 is an exploded diagram showing a first embodiment for a screw feeding apparatus of a screw gun of the present invention;

FIG. 2 is a first stereogram showing a screw feeding apparatus of a screw gun of the present invention;

FIG. 3 is a second stereogram showing a screw feeding apparatus of a screw gun of the present invention;

FIG. 4 is a side section view showing a screw feeding apparatus of a screw gun of the present invention;

FIG. 5 is a front section view showing a screw feeding apparatus of a screw gun of the present invention;

FIG. 6 is a schematic diagram showing a screw feeding apparatus of a screw gun of the present invention in use;

FIG. 7 is a front section view showing a second embodiment for a screw feeding apparatus of a screw gun of the present invention;

FIG. 8 is a stereogram showing a third embodiment for a screw feeding apparatus of a screw gun of the present invention.

### DETAILED DESCRIPTION OF THE PREFERRED EMBODIMENT

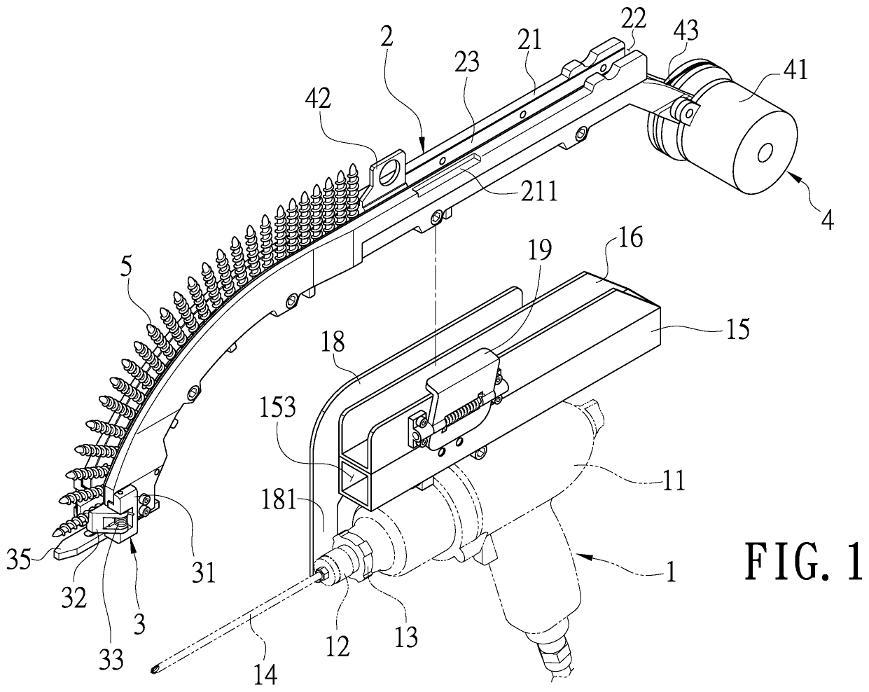

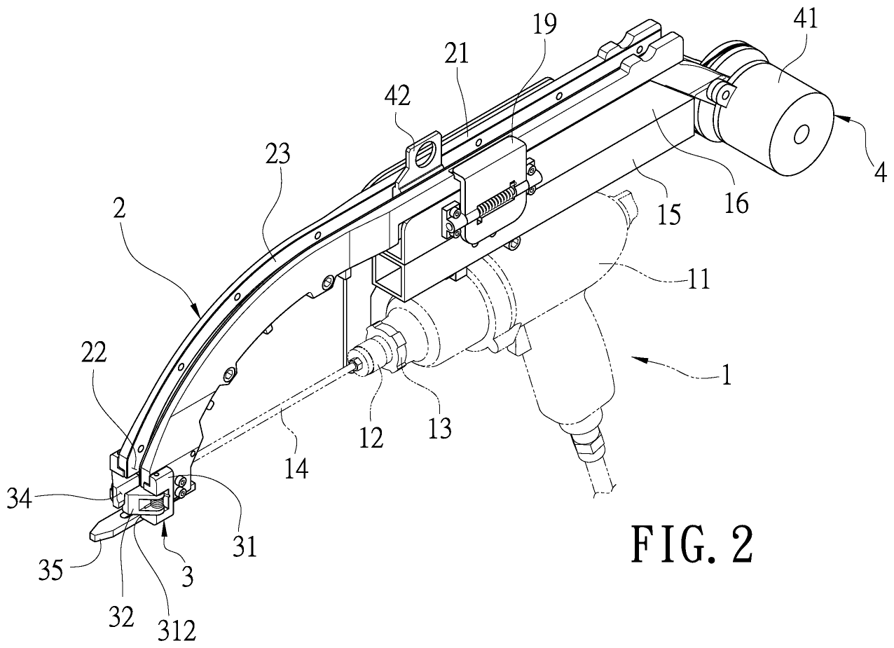

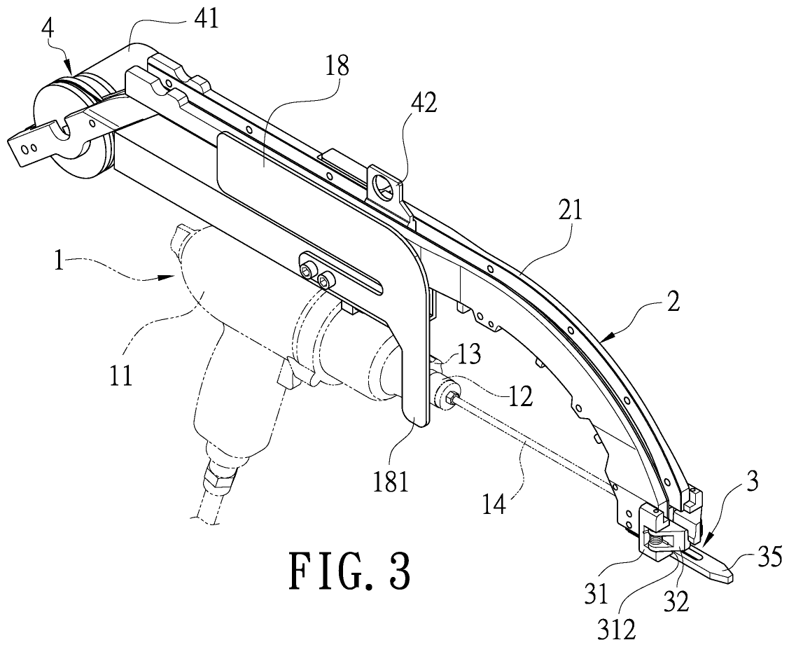

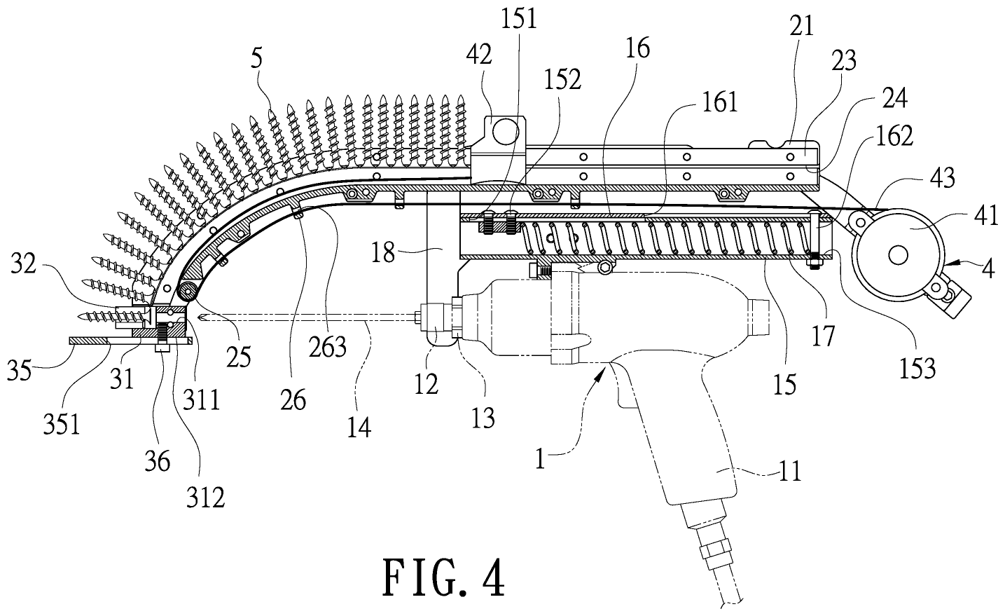

Referring to FIG. 1 to FIG. 4, the feeding apparatus of a screw gun comprises a screw gun (1), a screw cartridge (2), a screw die head (3) and a feeding assembly (4).

The screw gun (1) comprises a main body (11) provided with a rotary power source such as a motor, a transmission member (12) disposed at a front end of the main body (11) to connect the rotary power source, a cam (13) disposed on the transmission member (12), a drill rod (14) at a front end of the transmission member (12), a hollow coupling portion (15) connected to an upper side of the main body (11) and a cartridge holder (16) slidably connected to the coupling portion (15). The drill rod (14) has a flat-head or a cross-head corresponding to a screw head of a slotted screw or a Phillips screw respectively. The coupling portion (15) is provided with a first guide hole (151) at a front end, at least one first locking member (152) in the first guide hole (151) for contacting one end of a first elastic member (17) and a hollow portion (153) for accommodating the first elastic member (17). The cartridge holder (16) is provided with a second guide hole (161) at a rear end, a front end for locking into the at least one first locking member (152), and at least one second locking member (162) passing through the second guide hole (161) for locking and connecting a rear end of the coupling portion (15) and contacting the other end of the first elastic member (17). The screw gun (1) is further provided with a vibrating sheet (18) disposed on one side of the coupling portion (15) for contacting one side of the cartridge holder (16), and the vibrating sheet (18) has a knocking segment (181) extended to the cam (13) for contacting the cam (13). The cartridge holder (16) is further pivotally provided with a buckle (19) on the other side corresponding to the vibrating sheet (18).

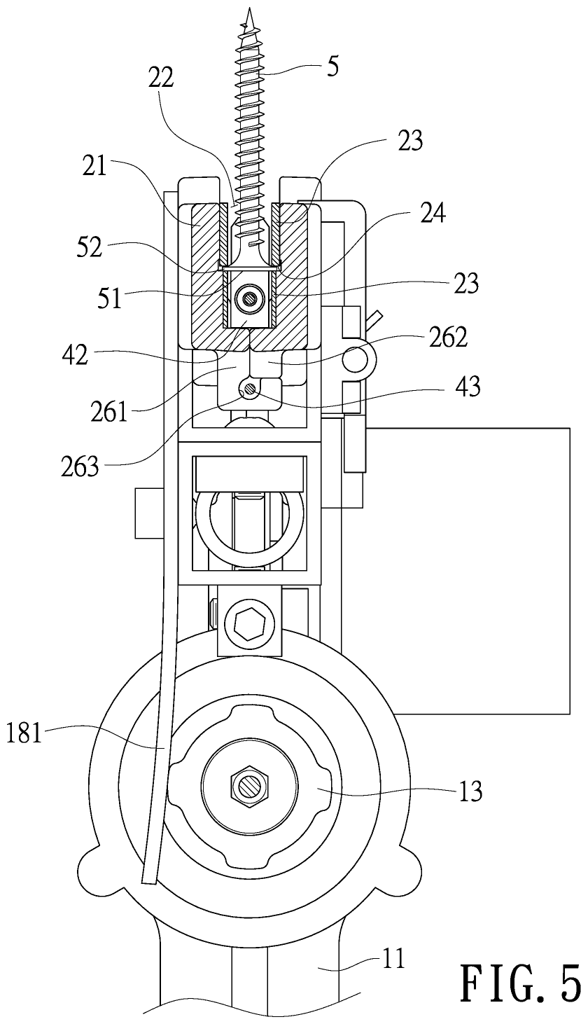

The screw cartridge (2) is disposed in the cartridge holder (16). Referring to FIG. 5, the screw cartridge (2) comprises two L-shaped positioning plates (21) correspondingly connecting to each other and a groove (22) formed between the two positioning plates (21). A front section of each of the two positioning plates (21) is bended downward to the front side of the drill rod (14) of the screw gun (1). The screw cartridge (2) is further provided with two guide sheets (23) respectively and longitudinally arranged on an upper side and a lower side of each of the two lateral walls of the groove (22), and a guide groove (24) is formed between the two guide sheets (23). The screw cartridge (2) has a notch adjacent to a front bottom of the groove (22) and a roller (25) disposed in the notch. A bottom of each of the two positioning plates (21) is connected to at least one guide block (26), in which a first guide block (261) connected to the positioning plate (21) is a hooked block, and a second guide block (262) connected to the positioning plate (21) is a rectangular block. The second guide block (262) with rectangle appearance is disposed at an hooked opening of the first guide block (261) to seal the hooked opening, thus a third guide hole (263) is formed between the first guide block (261) and the second guide block (262) in assembly. A top side of the positioning plate (21) adjacent to the buckle (19) of the cartridge holder (16) is provided with a buckle slot (211) for fastening to the buckle (19) correspondingly.

The screw die head (3) is connected to the front end of the two positioning plates (21) of the screw cartridge (2). The screw die head (3) comprises a fixing seat (31) for connecting to the front end of the two positioning plates (21) of the screw cartridge (2), two positioning blocks (32) respectively and pivotally connecting two laterals of the fixing seat (31), two second elastic members (33) respectively connecting the two positioning blocks (32) to the fixing seat (31), and a clamping space (34) between the two positioning blocks (32). A rear side of the fixing seat (31) corresponding to the clamping space (34) is provided with a through hole (311) which is corresponds to the drill rod (14). The fixing seat (31) is further provided with a chute (312) at a bottom, a supporting member (35) having a fourth guide hole (351) disposed longitudinally for connecting to the chute (312), and a third locking member (36) for passing through the fourth guide hole (351) of the supporting member (35) to lock to the bottom of the sixing seat (31). A length extended from the fixing seat (31) of the supporting member (35) and a length of the screw (5) used are matched to each other.

The feeding assembly (4) comprises a driving source (41) such as a scroll spring disposed at a rear end of the two positioning plates (21) of the screw cartridge (2), a pushing block (42) disposed in the groove (22) of the screw cartridge (2), a rope (43) having one end connected to the pushing block (42). The other end of the rope (43) is extended to the notch at the front bottom of the groove (22), winding to the roller (25) in the notch, and winding to the bottom of the two positioning plates (21) for penetrating the third guide hole (263) of the guide block (26) so as to connect the driving source (41) disposed at the rear end of the two positioning plates (21).

When using the present invention, plural screws (5) are filled into the groove (22) of the screw cartridge (2) assembled with the screw die head (3) and the feeding assembly (4) one by one to connect a guide flange (52) on a head (51) of the screw (5) to the guide groove (24) of the two lateral walls of the groove (22). After filling the screws (5), the last screw (5) is contacted by the pushing block (42) of the feeding assembly (4), the screw cartridge (2) is disposed in the cartridge holder (16) of the screw gun (1) and the buckle (19) of the cartridge holder (16) is fastened to the buckle slot (211) on the top side of one of the two positioning plates (21) to fix the screw cartridge (2) to the screw gum (1).

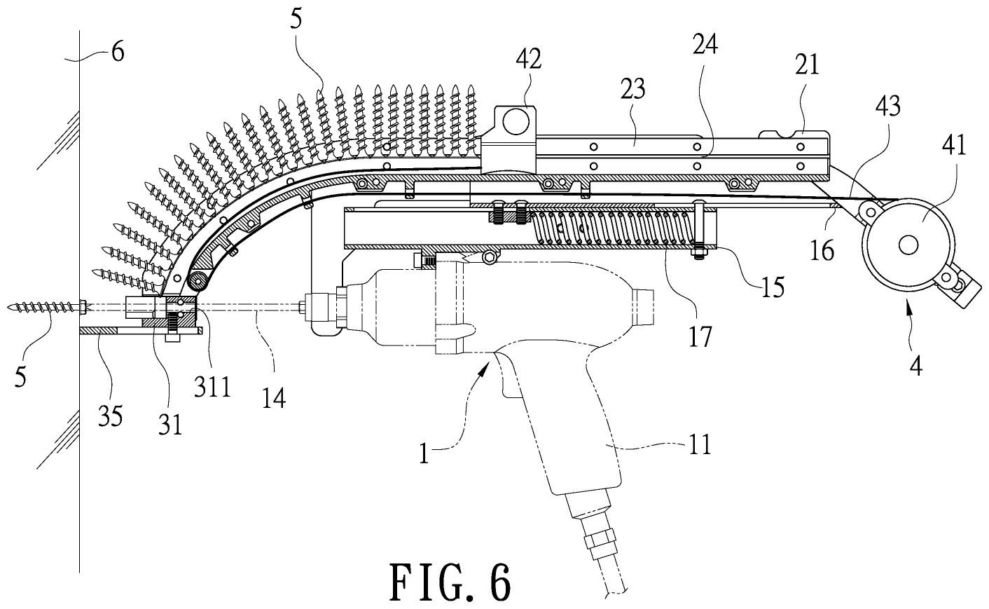

Please refer to FIG. 6, in a screw operation of an object (6), a user holds the screw gun (1) by at least one hand and contacts the supporting member (35) of the screw die head (3) to a surface of the object (6). When the screw die head (3) is contacted to the surface of the object (6) in which the screw cartridge (2) and the cartridge holder (16) are maintained in a fixed position, the main body (11) is then pushed forward to make the drill rod (14) disposed at the front end of the main body (11) pass through the through hole (311) of the fixing seat (31) of the screw die head (3) by a design of slidably deposing the cartridge holder (16) on the coupling portion (15) of the main body (11). The head (51) of the first screw (5) clamped by the two positioning blocks (32) of the screw die head (3) is then contacted and pushed by the drill rod (4) which makes a front end of the first screw (5) contact the surface of the object (6).

After that, the screw gun (1) is turned on and driven by the rotary power source to spin the drill rod (14) by the transmission member (12), and the first screw (5) contacted by the drill rod (14) is then driven to spin. At the same time, the first screw (5) is continuously pushed forward to release the first screw (5) from the two positioning blocks (32) of the screw die head (3) and screwed into two overlapped objects (6) for locking the two objects (6). Then, the supporting member (35) of the screw die head (3) is removed from the object (6), the first elastic member (17) between the coupling portion (15) and the cartridge holder (16) is returned to an original state from a compressed status due to a forward-pushing position of the main body (11). The first elastic member (17) returned to the original state then pushes the screw cartridge (2) and the screw die head (3) forward to remove the drill rod (14) from a space for clamping the screw (5) between the two positioning blocks (32) of the screw die head (3).

In addition, when the drill rod (14) is driven by the transmission member (12) of the screw gun (1), the cam (13) disposed on the transmission member (12) is rotated at the same time. The knocking segment (181) of the vibrating sheet (18) contacted the cam (13) is then knocked by the cam (13) due to a height difference caused by repeating lifting and lowering of the cam (13), and the screw cartridge (2) in the cartridge holder (16) is further vibrated by the vibrating sheet (18) to loose the screws (5) filled in the groove (22) of the screw cartridge (2). Then, the pushing block (42) contacted to the last screw (5) and pulled by the driving source (41) can push the screws (5) moving forward for placing a second screw (5) into the space between the two positioning blocks (32) of the screw die head (3) after the drill rod (14) is removed between the two positioning blocks (32) of the screw die head (3), and the drill rod (14) can be pushed again for screwing the object (6).

Accordingly, the present invention does not need using a screw belt to prevent generation of wastes such as a main part of a screw belt and achieve an environmental friendly benefit. Furthermore, the present invention saves cost and time for insertion the screws (5) into a screw belt, and prevents inconveniences in the subsequent screwing operation for screwing an object (6) if the screws (5) are not inserted properly due to missing few screws or tilting insertion.

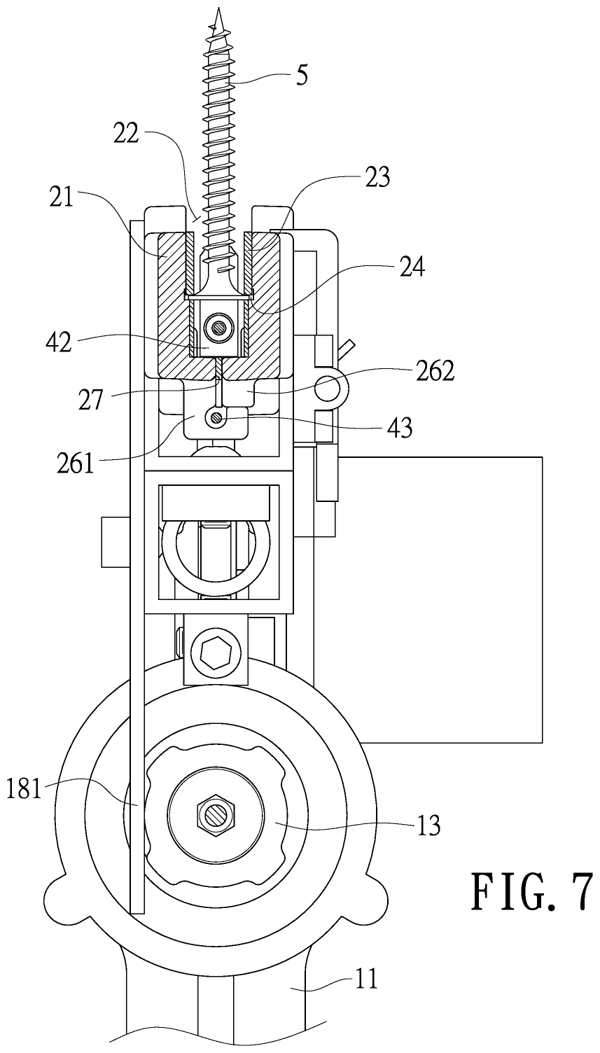

It is worth to mention, the guide sheet (23) in the screw cartridge (2) can be replaced with another guide sheet (23) having different thickness to form a guide groove (24) having different depth according to different sizes of the screws (5) filled in the screw cartridge (2), so different sizes of the screws (5) can be connected to the guide groove (24) of the screw cartridge (2) properly. Please refer to FIG. 7, the screw cartridge (2) of the present invention comprises two L-shaped positioning plate (21) connecting to each other and an extension pad (27) can be further provided between the two positioning plate (21) to broaden width of the groove (22) of the screw cartridge (2) for filling larger screws (5).

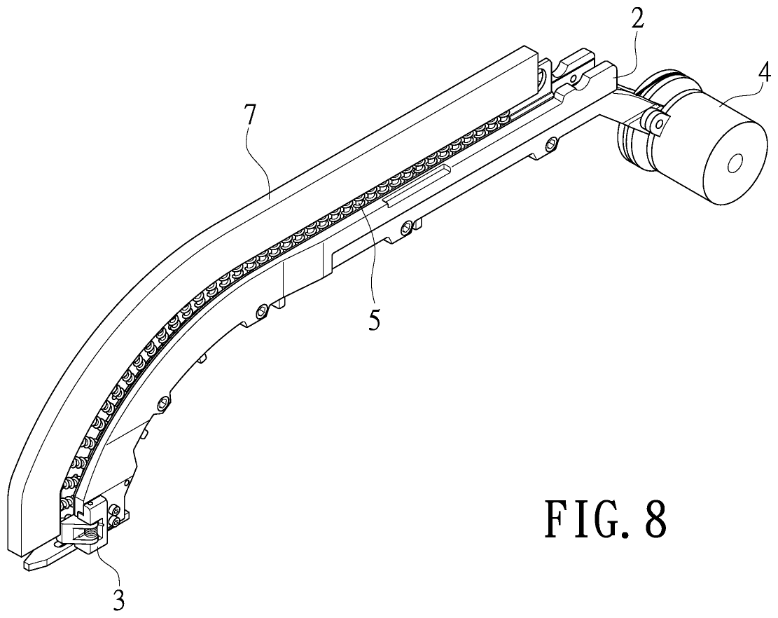

Please refer to FIG. 8, the present invention is further provided with a protection cover (7) longitudinally to the cartridge (2). The protection cover (7) has a nesting cavity inside to cover the screws (5) filled in the screw cartridge (2) when the present invention is not in use. The screws (5) are positioned by walls of the nesting cavity which can prevent injuries caused by the screws (5) accidently for a user carrying the present invention. The protection cover (7) is removed from the screws (5) when the present invention is used to screw an object (6) in a screw operation.

What is claimed is:

1. A screw feeding apparatus of a screw gun, comprising:
a screw gun having a main body provided with a rotary power source, a transmission member disposed at a front end of the main body to connect the rotary power source, a drill rod at a front end of the transmission member, a coupling portion connected to an upper side of the main body, and a cartridge holder slidably connected to the coupling portion;
a screw cartridge disposed in the cartridge holder and having a front end on a front side of the drill rod and a groove longitudinally disposed on a side thereof;
a screw die head disposed at the front end of the screw cartridge and corresponding to the drill rod; and
a feeding assembly disposed at a rear end of the screw cartridge.

2. The screw feeding apparatus of a screw gun as claimed in claim 1, wherein the screw cartridge is provided with two guide grooves respectively on two lateral walls of the groove and corresponding to each other.

3. The screw feeding apparatus of a screw gun as claimed in claim 2, wherein the screw cartridge is provided with two guide sheets respectively and longitudinally arranged on an upper side and a lower side of each of the two lateral walls of the groove, and wherein each of the two guide grooves is formed between the two guide sheets.

4. The screw feeding apparatus of a screw gun as claimed in claim 1, wherein a first elastic member is further provided between the coupling portion on the main body and the cartridge holder.

5. The screw feeding apparatus of a screw gun as claimed in claim 4, wherein the coupling portion is provided with a first guide hole at a front end thereof, at least one first locking member in the first guide hole for contacting one end of the first elastic member and a hollow portion for accommodating the first elastic member, and wherein the cartridge holder is provided with a second guide hole at a rear end thereof, a front end for locking into the at least one first locking member, and at least one second locking member passing through the second guide hole for locking and connecting a rear end of the coupling portion and contacting the other end of the first elastic member.

6. The screw feeding apparatus of a screw gun as claimed in claim 1, wherein the screw die head comprises a fixing seat for connecting to the front end of the screw cartridge and having a through hole on a rear side thereof for corresponding to the drill rod of the screw gun, two positioning blocks respectively and pivotally connecting two laterals of the fixing seat, two second elastic members respectively connecting the two positioning blocks to the fixing seat, and a clamping space between the two positioning blocks and corresponding to the through hole.

7. The screw feeding apparatus of a screw gun as claimed in claim 6, wherein the crew die head is provided with a chute at a bottom of the fixing seat, a supporting member having a fourth guide hole for connecting the chute, and a third locking member for passing through the fourth guide hole of the supporting member to lock the bottom of the fixing seat.

8. The screw feeding apparatus of a screw gun as claimed in claim 1, wherein the screw cartridge comprises two L-shaped positioning plates correspondingly connecting to each other and a groove formed between the two positioning plates, wherein a front section of each of the two positioning plates is bend downward to the front side of the drill rod of the screw gun for connecting to the screw die head, and a rear section of each of the two positioning plates is connected to the feeding assembly.

9. The screw feeding apparatus of a screw gun as claimed in claim 8, wherein the screw cartridge has a notch adjacent to a front bottom of the groove thereof, at least one guide block at a bottom of each of the two positioning plates for connecting the two positioning plates and further having a third guide hole, and wherein the feeding assembly comprises a driving source disposed at a rear end of the two positioning plates of the screw cartridge, a pushing block disposed in the groove of the screw cartridge, a rope having one end connected to the pushing block and the other end extended to the notch at the front bottom of the groove and winding to the bottom of the two positioning plates for penetrating the third guide hole of the guide block so as to connect the driving source disposed at the rear end of the two positioning plates.

10. The screw feeding apparatus of a screw gun as claimed in claim 1, wherein the screw gun is provided with a cam on the transmission member thereof, and a vibrating sheet disposed on one side of the coupling portion on the upper side of the main body for contacting one side of the cartridge holder, and wherein the vibrating sheet has a knocking segment extended to the cam for contacting the cam.
